(19) United States
(12) Patent Application Publication
(10) Pub. No.: US 2003/0151350 A1
(43) Pub. Date: Aug. 14, 2003

(54) Cold cathode type fluorescent lamp

(76) Inventor: Xiaoming Xu, Beijing (CN)

Correspondence Address: RABIN & CHAMPAGNE, PC, 1101 14TH STREET, NW, SUITE 500, WASHINGTON, DC, 20005, US

(21) Appl. No.: 10/327,917

(22) Filed: Dec. 26, 2002

(30) Foreign Application Priority Data
Dec. 28, 2001 (CN) 01274771.8
Oct. 18, 2002 (CN) 02281944.4

(51) Int. Cl. H01J 1/62; H01J 63/04

(52) U.S. Cl. 313/485; 313/641

(57) ABSTRACT

Disclosed is a cold cathode type fluorescent lamp operated with a low voltage while it has a greatly increased life. The cold cathode type fluorescent lamp has a fluorescent tube including a fluorescent material formed thereon. A discharge gas includes vapors of mercury and an inert gas by a ratio of approximately 1:0.6 to 1:2.0. A first base and a second base are installed at both end portions of the fluorescent tube. A first electrode is disposed in the fluorescent tube, and a second electrode is disposed in the fluorescent tube. A first electron-emitting member is fixed on the first electrode, and a second electron-emitting member is fixed on the second electrode. The cold cathode type fluorescent lamp can instantaneously operate without preheating the electrodes, and cold cathode type fluorescent lamp can have greatly increased life because the cold cathode type fluorescent lamp can continuously operate when the electron-emitting members are broken. Also, the cold cathode type fluorescent lamp can be employed for various purposes like a traffic lamp or a street lamp because the cold cathode type fluorescent lamp has the sufficient luminous intensity.

### BACKGROUND OF THE INVENTION

1. Field of the Invention

The present invention relates to a cold cathode type fluorescent lamp, and more particularly to a cold cathode type fluorescent lamp having sufficient luminous intensity and a greatly increased life while it can be economically manufactured and advantageously maintained.

2. Description of the Related Art

In general, the conventional fluorescent lamp has a glass tube including a fluorescent material coated on an inner wall thereof, and a vapor of mercury (Hg) filled therein. The mercury vapor emits ultraviolet rays, and the fluorescent material radiates visible rays after the fluorescent receives the ultraviolet rays emitted from the mercury vapor. The fluorescent lamp shows various colors according to the sorts of the fluorescent materials. The mercury vapor and an argon (Ar) vapor are filled in the glass tube of the fluorescent lamp in order to generate the ultraviolet rays by applying electrons emitted from a filament to the vapors of mercury and argon. The filament includes a double or a triple coil. A metal oxide is coated on a surface of the filament to emit the electrons at a high temperature.

As for the conventional fluorescent lamp, the filament is heated for a predetermined time after a current is applied to the filament. Then, thermal electrons are emitted from the metal oxide. At that time, the filament should be heated at a high temperature of above approximately 2,000° C. in order to emit the thermal electrons. The thermal electrons move by an electric field generated in the fluorescent tube, and the thermal electrons collide with the vapors of mercury and argon to excite mercury atoms and argon atoms. The ultraviolet rays are generated from the excited mercury atoms, and inputted onto the fluorescent material. The fluorescent material receives the ultraviolet rays, and then emits the visible rays. The fluorescent lamp is disclosed at U.S. Pat. No. 6,400,097 (issued to Feng Jin et al.), Japanese Laid Open Patent Publication No. 2002-237224, and Japanese Laid Open Patent Publication No. 2002-184354.

FIG. 1 is a partially projected perspective view illustrating the conventional fluorescent lamp.

Referring to FIG. 1, the conventional fluorescent lamp 10 includes a transparent glass tube 15, a pair of electrode structures 30, a discharge gas 40 including mercury (Hg), argon (Ar), and krypton (Kr), a pair of bases 35, an ultraviolet ray reflection layer 20, and a fluorescent material 25.

The electrode structures 30 are installed in both end portion of the glass tube 15, and the discharge gas 40 is sealed in the glass tube 15. The bases 40 are mounted at the end portions of the glass tube 15, and the ultraviolet ray reflection layer 20 is coated on an inside of the glass tube 15. The fluorescent material 25 is formed on the ultraviolet ray reflection layer 20.

The fluorescent lamp 10 can operates with a low voltage, and can have relatively high discharge efficiency because the discharge gas 40 includes vapors of mercury, argon and krypton. However, an inside of the glass tube 15 should be preliminarily heated when the fluorescent lamp 10 operates so that the fluorescent lamp 10 cannot be instantaneously operated because a predetermined time is required for generating visible rays from the glass tube 15 after currents are applied to the electrode structures 30. Also, because the fluorescent lamp 10 has the electrode structures 30 including filaments in order to emit electrons, the filaments of the electrode structures 30 may be easily broken so that the fluorescent lamp 10 may not have a long life. Namely, the glass tube 15 of the fluorescent lamp 10 is heated by heating the filaments, and the thermal electrons are emitted from the filaments by abruptly applying a high voltage to the filaments so that the filaments may be easily damaged, thereby reducing a life of the fluorescent lamp 10. In addition, lateral portions of the glass tube 15 becomes dark because much heat is generated from the electrode structures 30 positioned at the lateral portions of the glass tube 15. Hence, the fluorescent lamp 10 may have more reduced life. Furthermore, the fluorescent lamp 10 may consume much energy when the fluorescent lamp 10 is frequently turned on or turned off since the predetermined time is demanded for emitting the thermal electrons from the filaments.

To overcome the above-mentioned problems, cold cathode fluorescent lamps have been developed. The cold cathode fluorescent lamps are disclosed at U.S. Pat. No. 5,905,334 (issued to Osamu Nakamura et al.), U.S. Pat. No. 5,723,952 (issued to Sadayuki Matsumoto et al.), and Japanese Laid Open Patent No. 2001-43829.

FIG. 2 is a schematic cross-sectional view illustrating the conventional cold cathode fluorescent lamp.

Referring to FIG. 2, the conventional cold cathode fluorescent lamp 50 includes a fluorescent tube 55, a pair of electron-emitting electrodes 60 and 65, a pair of leads 70 and 75, and a discharge gas.

A fluorescent material is coated on an inside of the fluorescent tube 55, and the electron-emitting electrodes 60 and 65 are installed in the fluorescent tube 55. The electron-emitting electrodes 60 and 65 have base plates and electron-emitting films, respectively. The leads 70 and 75 are prolonged from the electron-emitting electrodes 60 and 65. The discharge gas includes mercury gas and a rare gas.

The cold cathode fluorescent lamp 50 can operate with a low discharge inception voltage, and have long life since the electron-emitting electrodes 60 and 65 are composed of rare earth materials.

However, because the conventional cold cathode fluorescent lamp 50 has a small size and limited luminous intensity, the conventional cold cathode fluorescent lamp 50 cannot be used for various applications and cannot be installed at a position where a high lighting is demanded though it can applied for a small lighting employed for an optical system or a screen of a computer.

### SUMMARY OF THE INVENTION

The present invention has been made to solve the afore-mentioned problems and accordingly, it is an object of the present invention to provide a cold cathode type fluorescent lamp having a long life, which can operate with a low voltage, and can provide sufficient luminous intensity.

It is another object of the present invention to provide a cold cathode type compact fluorescent lamp including a ballast installed therein, which can have a greatly increased life and sufficient lighting.

It is still another object of the present invention to provide a cold cathode type fluorescent lamp employed for a various applications including a traffic lamp or a street lamp.

It is still another object of the present invention to provide a cold cathode type fluorescent lamp economically manufactured and advantageously maintained while it has a long life and a sufficient luminous intensity.

It is still another object of the present invention to provide a cold cathode type fluorescent lamp that can stably operate under a severe circumstance like a very cold or dry region.

In order to achieve the objects of the present invention, the cold cathode type fluorescent lamp of one preferred embodiment comprises a fluorescent tube, a discharge gas, a first base, a second base, a first electrode, a second electrode, a first electron-emitting member, and a second electron-emitting member.

A fluorescent material is formed on an inside of the fluorescent tube, and the discharge gas filled in the fluorescent tube. At that time, the discharge gas includes a vapor of mercury and a vapor of an inert gas, and the vapor of the inert gas includes a vapor of an argon gas. Preferably, a weight ratio between the vapor of mercury and the vapor of argon is between approximately 1:0.6 and 1:2.0.

The first and the second bases are installed at both end portions of the fluorescent tube, respectively. The first electrode is disposed in the fluorescent tube wherein the first electrode is adjacent to the first base, and the second electrode is positioned in the fluorescent tube wherein the second electrode is adjacent to the second base.

The first and the second electron-emitting members are fixed on the first and the second electrodes, respectively. The first and the second electron-emitting members include tungsten, nickel or titanium carbide. In addition, the first and the second electron-emitting members have coil shapes or spring shapes formed by twisting about three to five strings, and electron powders are formed on surfaces of the first and the second electron-emitting members, respectively.

Preferably, a first fixing member and a second fixing member are formed to for fix the first and the second electron-emitting members on the first and the second electrodes, respectively. In this case, the first and the second fixing members include solderings, rivets, or holes formed through the first and the second electrodes.

More preferably, at least one discharge-improving member is disposed behind at least one of the first and the second electrodes. The discharge-improving member includes a reflection member for reflecting electrons emitted from at least one of the first and the second electron-emitting members, and a supporting member for supporting the reflection member. In this case, the reflection member includes material having a thermal expansion coefficient identical to at least one of the first and the second electrodes such as glass or quartz.

According to one preferred embodiment of the present invention, at least one of the first and the second electrodes extends toward a peripheral portion of the fluorescent tube.

To achieve the objects of the present invention, a cold cathode type fluorescent lamp of anther preferred embodiment comprises at least one fluorescent tube, a discharge gas filled in the fluorescent tube, a base for receiving both end portions of the fluorescent tube, a first electrode disposed in a first portion of the fluorescent tube, and a second electrode disposed in a second portion of the fluorescent tube, a first electron-emitting member, and a second electron-emitting member.

A fluorescent material is formed on an inside of the fluorescent tube. The first electrode is adjacent to a first portion of the base, and the second electrode is adjacent to a second portion of the base. The first and the second electron-emitting members are fixed on the first and the second electrodes, respectively.

Preferably, the fluorescent tube includes a first and a second fluorescent tubes disposed parallel to each other, and a connecting member is disposed between the first and the second fluorescent tubes in order to connect the first fluorescent to the second fluorescent tube. At that time, the first and the second electrodes are positioned in the first and the second fluorescent tubes, respectively.

More preferably, at least one discharge-improving member is installed behind at least one of the first and the second electrodes. The discharge-improving member includes a reflection member for reflecting electrons emitted from at least one of the electron-emitting members toward the discharge gas, and a supporting member for supporting the reflection member.

Also, to achieve the objects of the present invention, a cold cathode type compact fluorescent lamp of still anther preferred embodiment comprises a base, a ballast, at least one fluorescent tube, a discharge gas filled in the fluorescent tube, a first electrode, a second electrode, a first electron-emitting member, and a second electron-emitting member.

The base includes a housing having a first portion to which a socket is coupled, and a plate connected to a second portion of the housing. The base receives both end portions of the fluorescent tube. The ballast is installed in the housing. The fluorescent tube is installed on the plate, and a fluorescent material is formed on an inside of the fluorescent tube. The first electrode disposed in a first portion of the fluorescent tube, and the first electrode is adjacent to a first portion of the base. The second electrode disposed in a second portion of the fluorescent tube, and the second electrode is adjacent to a second portion of the base. The first and the second electron-emitting members are fixed on the first and the second electrodes, respectively.

According to another preferred embodiment of the present invention, the fluorescent tube includes a first, a second, and a third fluorescent tubes disposed parallel to one after another. At that time, a first connecting member is disposed between the first and the second fluorescent tubes in order to connect the first fluorescent to the second fluorescent tube, and a second connecting member is disposed between the first and the third fluorescent tubes in order to connect the first fluorescent to the third fluorescent tube. The first and the second electrodes are positioned in a first portion and a second portion of the first fluorescent tube, respectively, and at least one discharge-improving member is installed behind at least one of the first and the second electrodes. The discharge-improving member includes a reflection member for reflecting electrons emitted from at least one of the electron-emitting members toward the discharge gas, and a supporting member for supporting the reflection member.

According to still another preferred embodiment of the present invention, the fluorescent tube includes a linear portion prolonged from the plate in an upward direction, and a coil portion spirally prolonged toward the plate in a downward direction. In this case, the coil portion of the fluorescent tube can gradually extend toward the plate.

The cold cathode type fluorescent lamp of the present invention is quite different from the conventional fluorescent lamp. The cold cathode type fluorescent lamp can instantaneously operate without pre-heating the electrodes, and cold cathode type fluorescent lamp can have greatly increased life in comparison with the conventional fluorescent lamp because the cold cathode type fluorescent lamp can continuously operate when the electron-emitting members are broken. Also, the cold cathode type fluorescent lamp of the present invention can be employed for various purposes like a traffic lamp or a street lamp because the cold cathode type fluorescent lamp of the present invention has the sufficient luminous intensity while the conventional cold cathode fluorescent lamp has the limited luminous intensity for a small lighting. In addition, the cold cathode type fluorescent lamp of the present invention can have more enhanced discharge efficiency due to the discharge-improving member so that the cold cathode type fluorescent lamp of the present invention can be advantageously applied to a place where a large lighting is demanded. Furthermore, because the cold cathode type fluorescent lamp of the present invention can stably operate under a severe circumstance like a very cold or dry region, the cold cathode type fluorescent lamp of the present invention can have various applications.

### BRIEF DESCRIPTION OF THE DRAWINGS

The above and other objects and advantages of the present invention will become readily apparent by reference to the following detailed description when considered in conjunction with the accompanying drawings wherein:

FIG. 1 is a partially projected perspective view illustrating the conventional fluorescent lamp;

FIG. 2 is a schematic cross-sectional view illustrating the conventional cold cathode fluorescent lamp;

FIG. 3 is a projected perspective view illustrating a cold cathode type fluorescent lamp according to a first embodiment of the present invention;

FIG. 4 is a partially enlarged cross-sectional view showing the cold cathode type fluorescent lamp in FIG. 3;

FIG. 5 is a cross-sectional view illustrating a cold cathode type fluorescent lamp according to a second embodiment of the present invention;

FIG. 6 is a cross-sectional view illustrating a cold cathode type fluorescent lamp according a third embodiment of the present invention;

FIG. 7 is partially projected perspective view illustrating a cold cathode type fluorescent lamp according to a fourth embodiment of the present invention;

FIG. 8 is a partially projected plane view illustrating a cold cathode type fluorescent lamp according to a fifth embodiment of the present invention;

FIG. 9 is an exploded perspective view illustrating a cold cathode type compact fluorescent lamp according to a sixth embodiment of the present invention;

FIG. 10 is a perspective view showing a ballast in FIG. 9;

FIG. 11 is a partially projected perspective view illustrating a cold cathode type compact fluorescent lamp according to a seventh embodiment of the present invention;

FIG. 12 is a partially cut perspective view illustrating a cold cathode type compact fluorescent lamp according to an eight embodiment of the present invention;

FIG. 13 is a partially cut perspective view illustrating a cold cathode type compact fluorescent lamp according to a ninth embodiment of the present invention; and

FIG. 14 is a partially projected perspective view illustrating a cold cathode type compact fluorescent lamp according to a tenth embodiment of the present invention.

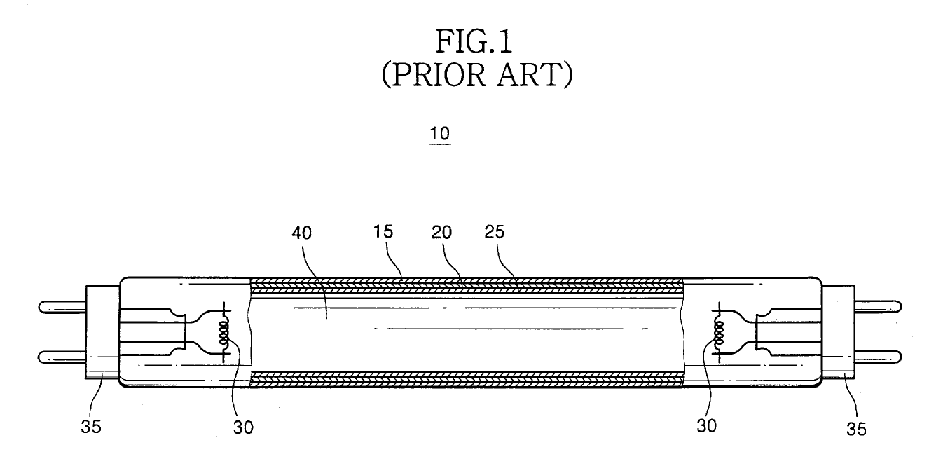

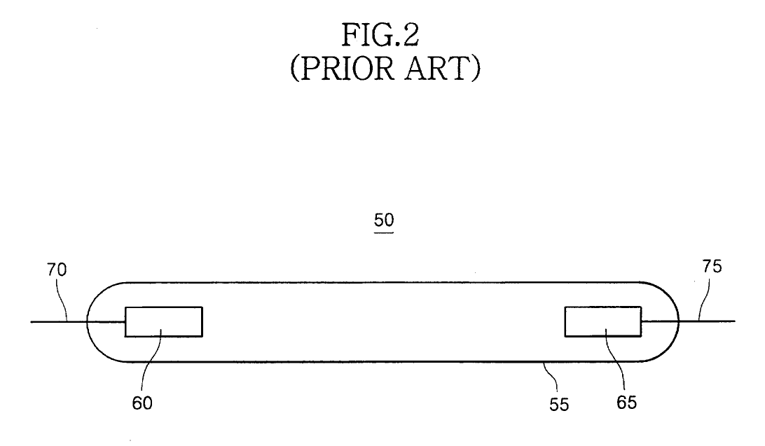

### DESCRIPTION OF THE PREFERRED EMBODIMENTS

Hereinafter, the preferred embodiments of the present invention will be described in detail with reference to the accompanying drawings. In the following drawings, like reference numerals identify similar or identical elements.

Embodiment 1

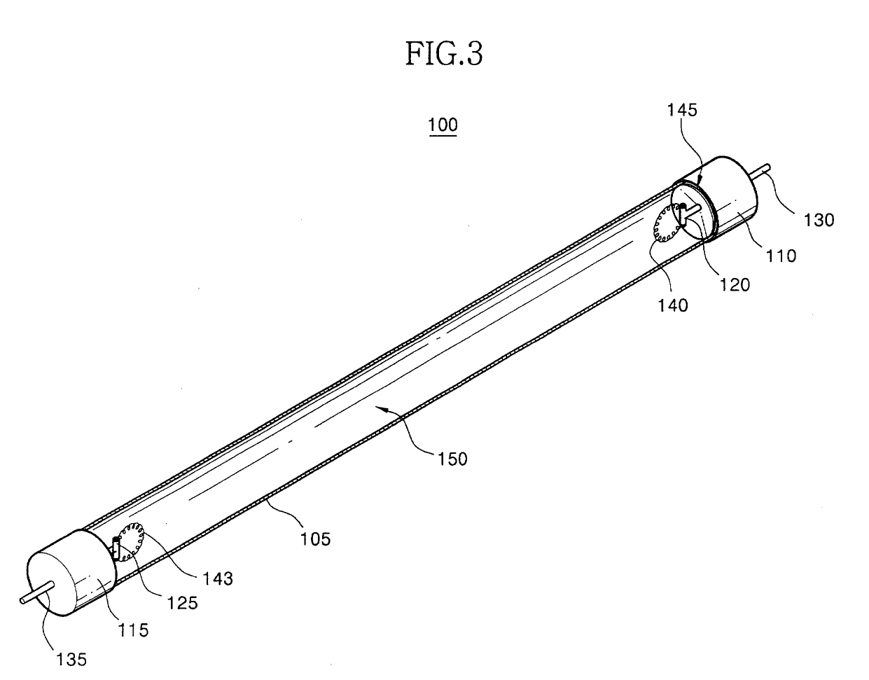

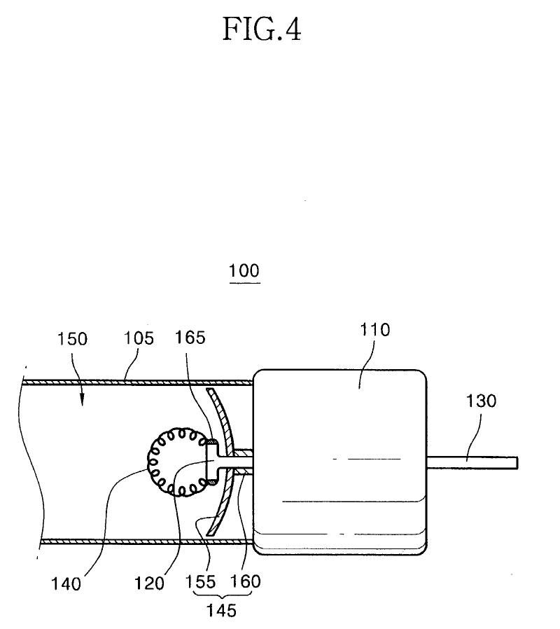

FIG. 3 is a projected perspective view illustrating a cold cathode type fluorescent lamp according to a first embodiment of the present invention, and FIG. 4 is a partially enlarged cross-sectional view showing a first base of the cold cathode type fluorescent lamp in FIG. 3.

Referring to FIGS. 3 and 4, the cold cathode type fluorescent lamp 100 has a fluorescent tube 105, a first base 110, a second base 115, a first electrode 120, a second electrode 125, a first lead 130, a second lead 135, a first electron-emitting member 140, a second electron-emitting member 143, a discharge-improving member 145, and a discharge gas 150.

The fluorescent tube 105 has a diameter of approximately 8 to 17 mm, and a length of approximately 600 to 1,600 mm in accordance with a power dissipation of the cold cathode type fluorescent lamp 100. A fluorescent material is coated on an inner wall of the fluorescent tube 105, and the discharge gas 150 is uniformly filled in the fluorescent tube 105. The discharge gas 150 includes vapors of mercury (Hg) and an inert gas. The fluorescent material includes a fluorescent substance, an adhesive, and aluminum oxide (Al₂O₃). The fluorescent material is coated on the inner wall of the fluorescent tube 105 after the fluorescent material is formed as a paste by mixing the fluorescent substance, the adhesive and aluminum oxide with water. The fluorescent substance substantially includes a base metal mixed with an oxide such as boric acid, silicic acid, phosphoric acid, or tungsten acid. The base metal mainly comprises magnesium (Mg), copper (Cu), cadmium (Cd), or zinc (Zn). The fluorescent substance additionally includes an activator composed of heavy metal like silver (Ag), manganese (Mn), copper (Cu), or lead (Pb). The adhesive in the fluorescent substance is decomposed when the fluorescent tube 105 is heated at a temperature of approximately 250 to 350° C. Table 1 shows dimensions of the fluorescent tubes 105 in accordance with the luminous intensities of the cold cathode type fluorescent lamp 100 of the present embodiment.

TABLE 1

| | | | | | | | | |
|---|---|---|---|---|---|---|---|---|
| luminous intensity | 20 | W | 30 | W | 40 | W | 70 | W |
| diameter of lamp | 8˜15 | mm | 15˜17 | mm | 15˜17 | mm | 17 | mm |
| length of lamp | 600 | mm | 800 | mm | 800 | mm | 1,600 | mm |

Referring to Table 1, though the diameter and the length of the fluorescent tube increase as the luminous intensity of the cold cathode type fluorescent lamp 100 increases, the luminous intensity of the cold cathode type fluorescent lamp 100 is mainly determined by the discharge gas 150 injected in the fluorescent tube 105. Hence, the dimensions of the fluorescent tubes 105 cannot be varied, or decreased though the luminous intensity of the cold cathode type fluorescent lamp 100 is increased.

Meanwhile, an ultraviolet reflection film can be formed between the fluorescent material and the inner wall of the fluorescent tube 105 in order to reflect ultraviolet rays generated from the discharge gas 150 including the vapor of mercury. The ultraviolet reflection film can prevent the ultraviolet rays from outwardly emitting, and also can reflect the ultraviolet rays toward an inside of the fluorescent tube 105 to increase a discharge efficiency of the cold cathode type fluorescent lamp 100. Namely, when the ultraviolet reflection film and the fluorescent material are successively coated on the inner wall of the fluorescent tube 105, the ultraviolet rays transmitting the fluorescent material is reflected toward the inside of the fluorescent tube 105 so that the luminous intensity of the cold cathode type fluorescent lamp 100 can be more augmented.

The discharge gas 150 filled in the fluorescent tube 105 includes the vapors of mercury and the inert gas like helium (He), argon (Ar), neon (Ne), krypton (Kr), or xenon (Xe). The discharge gas 150 of the present invention has the vapor of mercury and the vapor of the inert gas so that a discharge inception voltage of the cold cathode type fluorescent tube 100 can greatly decrease by employing Penning Effect caused from the mercury vapor and the predetermined inert gas vapor.

In general, the ionization energy of mercury is closely similar to that of argon because a first ionization energy of mercury is about 10.4 eV, and a first and a second ionization energies of argon are about 11.49 eV and 11.69 eV, respectively. Thus, when an argon vapor is added to the mercury vapor, the Penning Effect can be easily induced so that the discharge inception voltage of the cold cathode fluorescent tube 100 can be reduced. In this case, argon should have a high purity since a purity of argon has a great affect on the reduction of the discharge inception voltage. In the present invention, the argon gas has a very high purity of above approximately 99.998%. Preferably, a ratio of the vapors of mercury and argon in the discharge gas 150 is between approximately 1:0.6 and 1:2.0. Table 2 shows a composition of the discharge gas 150 in accordance with the luminous intensities of the cold cathode type fluorescent lamp 100.

TABLE 2

| luminous intensity | 20 W | 30 W | 40 W | 70 W |
|---|---|---|---|---|
| composition of | | | | |
| discharge gas | | | | |
| Hg vapor (mg) | 2.5˜3.5 | 3.0˜4.0 | 3.5˜4.5 | 4.0˜5.0 |
| Ar vapor (mg) | 4.5˜4.9 | 4.3˜4.7 | 3.6˜4.2 | 3.1˜3.8 |

As shown in Table 2, when the luminous intensity of the cold cathode type fluorescent lamp 100 is 20W, the ratio between the mercury vapor and the argon vapor in the discharge gas 150 is approximately 1:1.3 to 1:2.0. When the luminous intensities of the cold cathode type fluorescent lamp 100 are 30W and 40W, the ratios between the mercury vapor and the argon vapor in the discharge gas 150 are approximately 1:1.1 to 1:1.6, and approximately 1:0.8 to 1:1.2, respectively. Also, the ratio between the mercury vapor and the argon vapor in the discharge gas 150 is approximately 1:0.6 to 1:0.9 when the luminous intensity of the cold cathode type fluorescent lamp 100 is 70W. Though the argon vapor is added to the mercury vapor as the vapor of the inert gas, other vapors of the inert gases like helium, neon, krypton, or xenon can be added to the mercury vapor to obtain the reduction of the discharge inception voltage.

The first and the second bases 110 and 115 are installed at both end portions of the fluorescent tube 105, respectively. The first lead 130 is prolonged from the first electrode 120 positioned in a first portion of the fluorescent tube 105 through the first base 110, and the second lead 135 is prolonged from the second electrode 125 positioned in a second portion of the fluorescent tube 105 through the second base 115.

The first electron-emitting member 140 is attached to the first electrode 120, and the discharge-improving member 145 is installed between the first electrode 120 and the first base 110. In addition, the second electron-emitting member 143 is fixed on the second electrode 125. The first and the second electron-emitting members 140 and 143 have coil shapes or spring shapes, respectively.

As shown in FIG. 4, the first electron-emitting member 140 is attached to the first electrode 120 employing the fixing member 165. The first electron-emitting member 140 includes several strings composed of tungsten (W), nickel (Ni), or titanium carbide (TiC). Also, the second electron-emitting member 143 has several strings composed of tungsten, nickel, or titanium carbide. The first and the second electron-emitting members 140 and 143 have the coil shape or the spring shape in order to maximize areas where electrons are emitted. As for formations of the first and the second electron-emitting members 140 and 143, about three to five strings are twisted one after another to form the coil shapes or the spring shapes after about three or five strings are formed.

In the meantime, electron powers including calcium carbonate (CaCO3) are uniformly coated on surfaces of the first and the second electron-emitting members 140 and 143, thereby efficiently emitting the electrons from the electron powders and the electron-emitting members 140 and 143. When the electron power has a thick thickness, the electrons may be hardly emitted from the electron powders and the electron-emitting members 140 and 143. Preferably, the electron powders are uniformly coated on surfaces of the electron-emitting electrodes 140 and 143 by a thickness of below approximately 1 mm.

The first electron-emitting member 140 is fixed on the first electrode 120 by employing the fixing member 165 including a soldering or a minute rivet. The second electron-emitting member 143 is also fixed on the second electrode 125 by employing an additional fixing member including a soldering or a minute rivet. In addition, after minute holes are formed through the first and the second electrodes 120 and 125, the first and the second electron-emitting members 140 and 143 are fixed on the first and the second electrodes 120 and 125 by directly winding the first and the second electron-emitting members 140 and 143 about the first and the second electrodes 120 and 125, respectively. At that time, solderings are additionally formed between the electron-emitting members 140 and 143 and the electrodes 120 and 125 so as to increase fixing stabilities of the electron-emitting members 140 and 143.

The discharge-improving member 145 is disposed between the first electrode 120 and the first base 110. The discharge-improving member 145 includes a reflection member 155 and a supporting member 160.

The reflection member 155 substantially has a circular plate shape curved by a predetermined curvature. The reflection member 155 reflects the electrons emitted from the first electron-emitting member 140 toward the discharge gas 150 in the fluorescent tube 105, thereby improving the discharge efficiency of the cold cathode type fluorescent lamp 100. The reflection member 155 includes a material having a thermal expansion coefficient closely identical to that of the first electrode 120 so that the reflection member 155 cannot be separated from the first electrode 120 during a performance of the cold cathode type fluorescent lamp 100. Preferably, the reflection member 155 includes quartz, glass, or an alloy having a thermal expansion coefficient nearly identical to that of copper generally included in the first electrode 120.

The supporting member 160 is disposed behind the reflection member 155. The supporting member 160 also includes the material having a thermal expansion coefficient closely identical to that of the first electrode 120. The supporting member 160 has a hole having a predetermined diameter where the first electrode 120 is penetrated. One end portion of the supporting member 160 is fixed beneath the reflection member 155, and the other end portion of the supporting member 160 is attached to the end portion of the fluorescent tube 105. However, the supporting member 160 can be omitted in case that the reflection member 155 is directly attached to the first electrode 120. Additionally, because the discharge-improving member 145 is not essential to the cold cathode type fluorescent lamp 100, the discharge-improving member 145 may be omitted.

Though it is not shown, an additional discharge-improving member including a reflection member and a supporting member can be installed between the second electrode 125 and the second base 115 to improve the discharge efficiency of the cold cathode type fluorescent lamp 100. The additional discharge-improving member can be also omitted as the occasion demands.

In the present invention, when voltages are applied to the first and the second electron-emitting members 140 and 143 from a ballast through the first and the second electrodes 120 and 125, the electrons are emitted from the first and the second electron-emitting members 140 and 143 on which the electron powder are coated. Then, the electrons collide with the discharge gas 150 in the fluorescent tube 105 so that ultraviolet rays are emitted from the mercury vapor of the discharge gas 150. The ultraviolet rays are applied to the fluorescent material coated on the inner wall of the fluorescent tube 105, thereby generating visible lights from the cold cathode type fluorescent lamp 100 by a predetermined luminous intensity. At that time, the discharge inception voltage and a maintaining voltage are applied from the ballast to the first and the second electrodes 120 and 125. Table 3 shows the discharge inception and the maintaining voltages in accordance with the luminous intensities of the cold cathode type fluorescent lamp 100.

TABLE 3

| luminous intensity | 20 | W | 30 | W | 40 | W | 70 | W |
|---|---|---|---|---|---|---|---|---|
| discharge inception | 1,200˜1,500 V | | | | | | | |
| voltage | | | | | | | | |
| maintaining voltage | 120˜130 | V | 160˜200 | V | 220˜260 | V | 230˜270 | V |

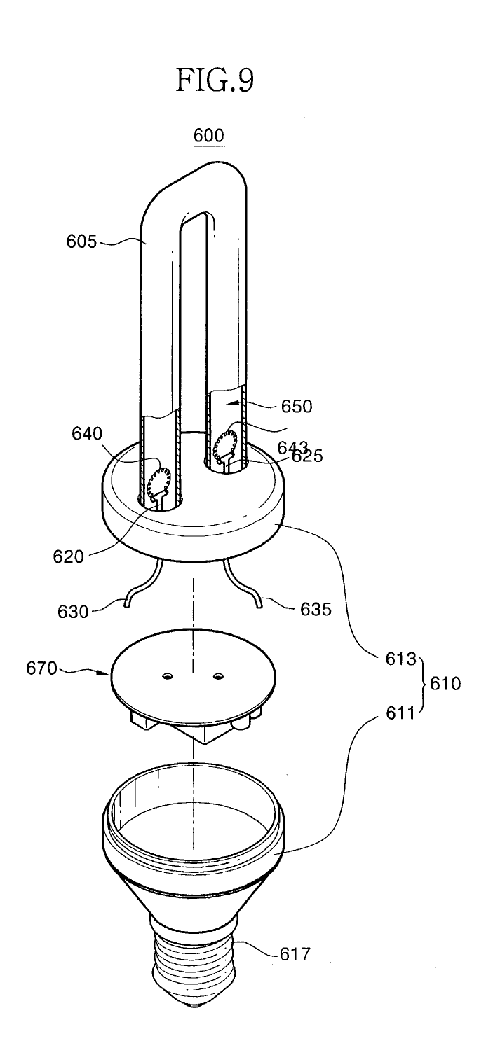

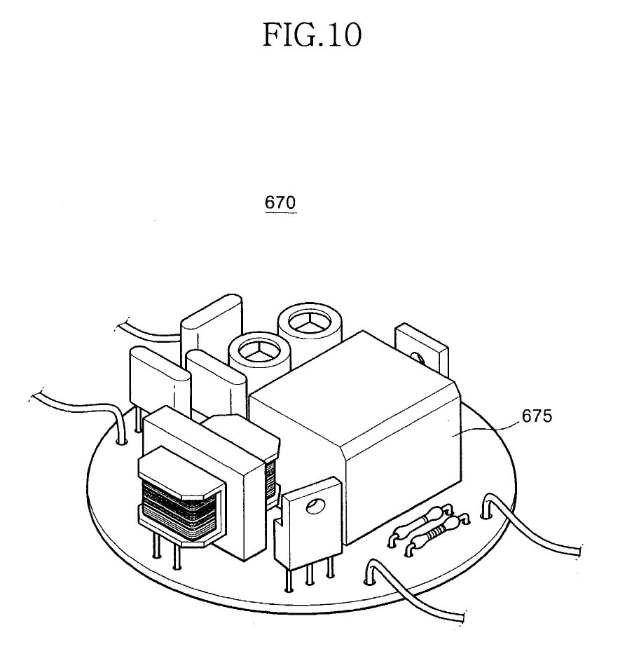

As shown in Table 3, the cold cathode type fluorescent lamp 100 can operate with a low discharge inception voltage of below approximately 1,500V, and a maintaining voltage of approximately 120 to 270V. The ballast providing the discharge inception and the maintaining voltages will be described with reference to FIGS. 9 and 10.

As for the cold cathode type fluorescent lamp 100 of the present embodiment, the cold cathode type fluorescent lamp 100 can have a greatly increased life of more than about 50,000 hours because the electrons can be continuously emitted from the first and the second electron-emitting members 140 and 143 by the voltages applied through the first and the second electrodes 120 and 125 though the first and the second electron-emitting members 140 and 143 may be broken during the operation of the cold cathode type fluorescent lamp 100. That is, the cold cathode type fluorescent lamp 100 can have a long life while the cold cathode type fluorescent lamp 100 can maintain an initial luminous intensity when the first or the second electron-emitting members 140 and 143 is broken. Also, because the cold cathode type fluorescent lamp 100 of the present invention utilizes a principle of a cold cathode ray, the cold cathode type fluorescent lamp 100 can be instantaneously turned on with the low discharge inception voltage in accordance with the Penning Effect without heating the electrodes 120 and 125. Thus, the cold cathode type fluorescent lamp 100 of the present invention can contribute to energy conservation.

Embodiment 2

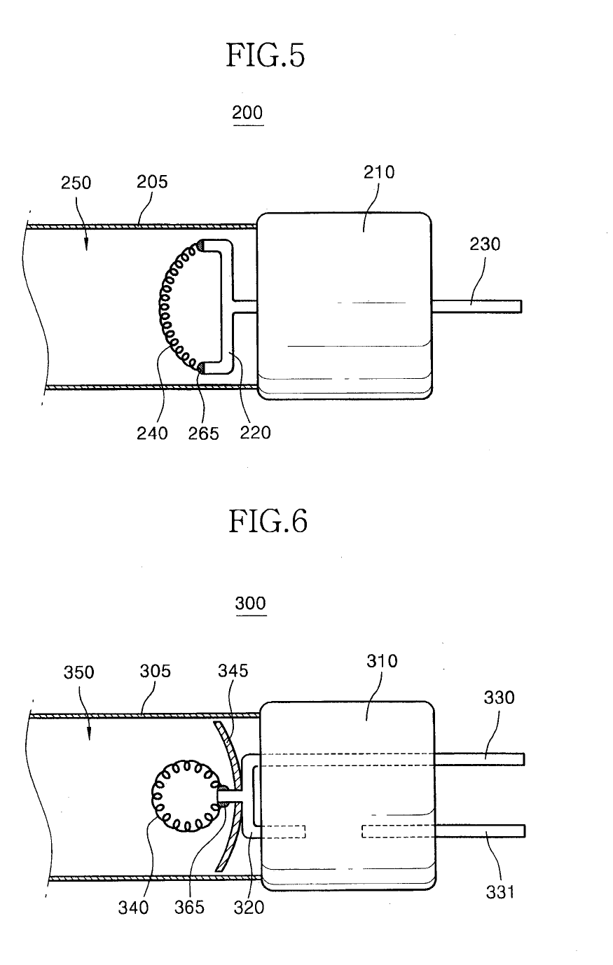

FIG. 5 is a cross-sectional view illustrating a cold cathode type fluorescent lamp according to a second embodiment of the present invention.

Referring to FIG. 5, a cold cathode type fluorescent lamp 200 of the present embodiment includes a fluorescent tube 205, a first base 210, a first electrode 220, a first lead 230, a first electron-emitting member 240, a discharge gas 250, and a fixing member 265.

In the present embodiment, a second base and a second lead are identical to those of the first embodiment. Thus, descriptions of those elements are omitted. In addition, a fluorescent material coated on an inner wall of the fluorescent tube 205 and the discharge gas 250 filled in the fluorescent tube 205 are identical to those of the first embodiment.

The first electrode 210 substantially has a sectional shape of ‘T’. Both end portions of the first electrode 210 are extended toward the inner wall of the fluorescent tube 205. The first electron-emitting member 240 includes electron powders having calcium carbonate coated thereon. The first electron-emitting member 240 is fixed at end portions of the first electrode 220 by using the fixing member 265 including a soldering, a rivet, or holes formed through end portions of the first electrode 220. The first electron-emitting member 240 includes a coil shape or a spring shape formed by twisting about three to five strings composed of tungsten, nickel or titanium carbide.

The cold cathode type fluorescent lamp 200 of the present embodiment has a second electrode and a second electron-emitting member identical to the first electrode and the first electron-emitting member, respectively. In this case, an additional fixing member can be formed in order to fix the second electron-emitting member to the second electrode.

According to the present embodiment, the first electrode 220 and the second electrode have structures extended toward the inner wall of the fluorescent tube 205 so that the first electrode 220 and the second electrode can reflect electrons emitted from the first electron-emitting member 240 and the second electron-emitting member toward the discharge gas 250 in the fluorescent tube 205. Namely, the electrons progressing toward the first base 210 and the second base are reflected through the first electrode 220 and the second electrode, respectively. Thus, a discharging efficiency of the cold cathode type fluorescent lamp 200 can be improved.

Also, according to the present embodiment, additional discharge-improving members may not be demanded because the electrodes 220 have the extended structures. Therefore, the cold cathode type fluorescent lamp 200 can have more simplified construction.

Embodiment 3

FIG. 6 is a cross-sectional view illustrating a cold cathode type fluorescent lamp according a third embodiment of the present invention.

Referring to FIG. 6, a cold cathode type fluorescent lamp 300 of the present embodiment has a fluorescent tube 305, a first base 310, a first electrode 320, a pair of first leads 330 and 331, a first electron-emitting member 340, a discharge-improving member 345, a discharge gas 350, and a fixing member 365.

In the present embodiment, a fluorescent material coated on an inner wall of the fluorescent tube 305 and the discharge gas 350 filled in the fluorescent tube 305 are identical to those of the first embodiment. Also, a second base, a second electrode, and a second electron-emitting member are the same as those of the first embodiment. Hence, descriptions of those elements are omitted.

According to the present embodiment, the cold cathode type fluorescent lamp 300 can be applied to the conventional fluorescent lamp receiving structure without a variation of the structure. Particularly, two first leads 330 and 331 are formed through the first base 310. At that time, one first lead 330 is electrically connected to the first electrode 320 while the other first lead 331 is not connected to the first electrode 320. Additionally, a pair of second leads is formed through the second base. One of the second lead is connected to the second electrode but the other second lead is not connected to the second electrode. Thus, the cold cathode type fluorescent lamp 300 of the present embodiment can be sufficiently employed to the structure for receiving the conventional fluorescent lamp.

The first electron-emitting member 340, the discharge-improving member 345, and the fixing member 365 are identical to those of the first embodiment.

Embodiment 4

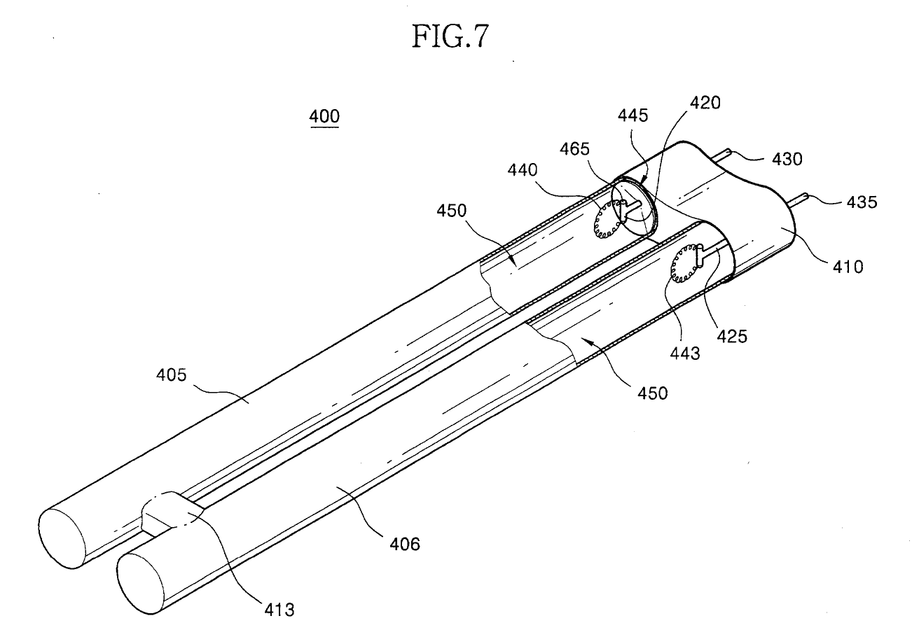

FIG. 7 is partially projected perspective view illustrating a cold cathode type fluorescent lamp according to a fourth embodiment of the present invention.

Referring to FIG. 7, a cold cathode type fluorescent lamp 400 of the present embodiment has a first fluorescent tube 405, a second fluorescent tube 406, a base 410, a first electrode 420, a second electrode 425, a first lead 430, a second lead 435, a first electron-emitting member 440, a second electron-emitting member 443, a discharge-improving member 445, a discharge gas 450, and a fixing member 465.

In the present embodiment, the cold cathode type fluorescent lamp 400 includes two fluorescent tubes 405 and 406 having identical dimensions in accordance with the luminous intensities of the cold cathode type fluorescent lamp 400 as it is described above.

Fluorescent materials are coated on inner walls of the first and the second fluorescent tubes 405 and 406, respectively. The discharge gas 450 including vapors of mercury and an inert gas is uniformly filled in the first and the second fluorescent tubes 405 and 406.

A first end portion of the first fluorescent tube 405 is connected to a first end portion of the second fluorescent tube 406 through a connecting member 413. Second end portions of the first and the second fluorescent tubes 405 and 406 are received in the base 410.

The first electrode 420 is positioned in the second end portion of the first fluorescent tube 405, and the second electrode 425 is positioned in the second end portion of the second fluorescent tube 406. The first lead 430 is prolonged from the first electrode 420 through a first portion of the base 410, and the second lead 435 is prolonged from the second electrode 425 through a second portion of the base 410.

The first electron-emitting member 440 is fixed on the first electrode 420 by using the fixing member 465. Electron powders are coated on the first electron-emitting member 440. The discharge-improving member 440 is disposed in the first fluorescent tube 405 between the first electrode 420 and the base 410. Also, the second electron-emitting member 443 having electron powders coated thereon is fixed on the second electrode 425 by using an additional fixing member. An additional discharge-improving member can be installed between the second electrode 425 and the base 410.

In the present embodiment, the first and the second electron-emitting members 440 and 443, the discharge-improving member 445, and the fixing member 465 are identical to those of the first embodiment. Thus, descriptions of those elements are omitted.

Embodiment 5

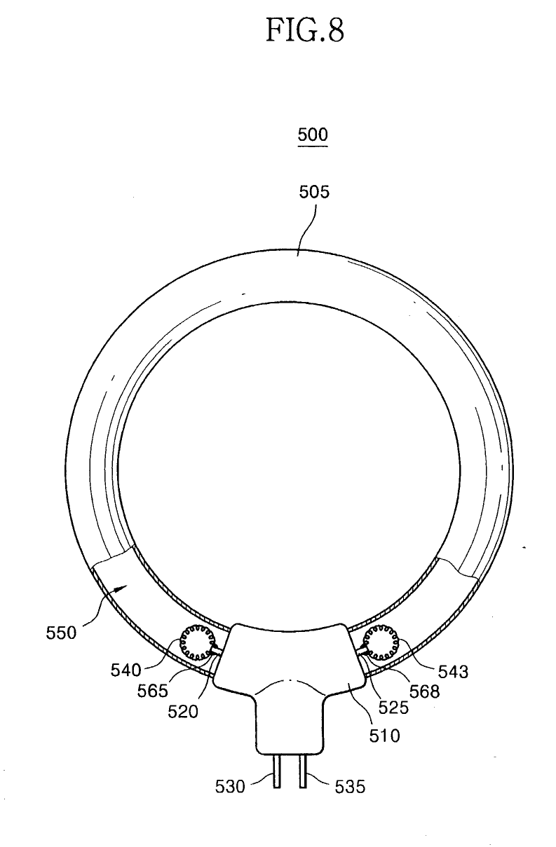

FIG. 8 is a partially projected plane view illustrating a cold cathode type fluorescent lamp according to a fifth embodiment of the present invention.

Referring to FIG. 8, a cold cathode type fluorescent lamp 500 of the present embodiment has a fluorescent tube 505, a base 510, a first electrode 520, a second electrode 525, a first lead 530, a second lead 535, a first electron-emitting member 540, a second electron-emitting member 543, a discharge-improving member 545, a discharge gas 550, a first fixing member 565, and a second fixing member 568.

The cold cathode type fluorescent lamp 500 of the present embodiment includes the fluorescent tube 505 having a ring shape. A fluorescent material is coated on an inner wall of the fluorescent tube 505, and the discharge gas 550 including vapors of mercury and an inert gas is filled in the fluorescent tube 505.

One end portion of the fluorescent tube 505 is inserted into a first portion of the base 510, and the other end portion of the fluorescent tube 505 is inserted into a second portion of the base 510. The first and the second electrodes 520 and 525 are positioned in both end portions of the fluorescent tube 505, respectively. The first electrode 520 is adjacent to the first portion of the base 510, and the second electrode 525 is adjacent to the second portion of the base 510.

The first lead 530 is prolonged from the first electrode 520 through the first portion of the base 510, and the second lead 535 is prolonged from the second electrode 525 through the second portion of the base 510.

The first and the second electron-emitting members 540 and 543 include about three to five strings composed of tungsten, nickel, or titanium carbide, respectively. The first and the second electron-emitting members 540 and 543 have coil shapes or spring shapes formed by twisting the strings. The first and the second electron-emitting members 540 and 543 are fixed on the first and the second electrodes 520 and 525 by employing the first and the second fixing members 565 and 568, respectively.

In the present embodiment, constructions of the first and the second electron-emitting members 540 and 543 are identical to those of the first embodiment. Additionally, a first discharge-improving member can be installed between the first electrode 520 and the first portion of the base 510, and a second discharge-improving member can be formed between the second electrode 525 and the second portion of the base 510 though they are not shown.

Embodiment 6

FIG. 9 is an exploded perspective view illustrating a cold cathode type compact fluorescent lamp according to a sixth embodiment of the present invention, and FIG. 10 is a perspective view showing a ballast in FIG. 9.

Referring to FIGS. 9 and 10, a cold cathode type compact fluorescent lamp 600 of the present embodiment has a fluorescent tube 605, a base 610, a socket 617, a first electrode 620, a second electrode 625, a first lead 630, a second lead 635, a first electron-emitting member 640, a second electron-emitting member 643, a discharge gas 650, and a ballast 670 installed in the base 610.

The base 610 includes a housing 611 and a plate 613. The socket 617 is coupled to a lower portion of the housing 611, and the plate 613 is mounted on an upper portion of the housing 611. The fluorescent tube 605 is installed on the plate 613. The fluorescent tube 605 substantially has a ‘U’ shape. Two holes are formed through the plate 613 in order to receive end portions of the fluorescent tube 605. A fluorescent material is uniformly coated on an inner wall of the fluorescent tube 605, and the discharge gas 650 is injected in the fluorescent tube 605. The discharge gas 650 includes vapors of mercury and an inert gas like helium, argon, neon, krypton, or xenon.

The first electrode 620 is positioned in one end portion of the fluorescent tube 605. The first lead 630 is prolonged from the first electrode 620 through the plate 613, and then is connected to the ballast 670. The first electron-emitting member 640 including tungsten, nickel, or titanium carbide is attached to the first electrode 620. At that time, a fixing member can be formed to increase a stability of the first electron-emitting member 640 with respect to the first electrode 620. Also, a discharge-improving member can be installed behind the first electrode 620 in order to enhance a discharge efficiency of the cold cathode type compact fluorescent lamp 600.

The second electrode 625 is disposed in the other end portion of the fluorescent tube 605. The second lead 635 is prolonged from the second electrode 625 through the plate 613, and then is connected to the ballast 670. The second electron-emitting member 643 including tungsten, nickel, or titanium carbide is fixed on the second electrode 625. In this case, an additional fixing member can be formed to increase a stability of the second electron-emitting member 643 with respect to the second electrode 625. Also, an additional discharge-improving member can be installed behind the second electrode 625 so as to enhance a discharge efficiency of the cold cathode type compact fluorescent lamp 600.

Two insertion holes are formed through the ballast 670 so that the first and the second leads 630 and 635 are inserted into the insertion holes for connecting the first and the second electrodes 620 and 625 to the ballast 670.

After the socket 617 is coupled to the lower portion of the housing 611, and the ballast 670 is installed in the housing 611, the plate 613 is attached to the upper portion of the housing 611, thereby completing the base 610. In this case, the plate 613 and the housing 611 can have screwed portions to combine each other.

The ballast 670 applies discharge inception voltages to the first and the second electrodes 620 and 625 when the cold cathode type compact fluorescent lamp 600 operates. Then, the ballast 670 applies stable maintaining voltages to the first and the second electrodes 620 and 625 after the cold cathode type compact fluorescent lamp 600 is turned on. As a result, numerous electrons are emitted from the first and the second electron-emitting members 640 and 643 including electron powders coated thereon. As shown in FIG. 10, the ballast 670 includes a fixing module 675 for fixing a circuit and improving a performance stability of the circuit. The ballast 670 further includes a DC-AC converting circuit, an oscillating circuit, and a protective circuit in order to perform the above-mentioned functions.

The ballast 670 provides the first and the second electrodes 620 and 625 with low voltages of approximately 1,200 to 1,500V when an initial discharge of the cold cathode type compact fluorescent lamp 600. Thus, a number of electrons can be emitted from the first and the second electrodes 620 and 625, and from the first and the second electron-emitting members 640 and 643. Also, the ballast 670 provides the first and the second electrodes 620 and 625 with low voltages of approximately 120 to 270V during a performance of the cold cathode type compact fluorescent lamp 600. Hence, numerous electrons can be continuously emitted from the first and the second electrodes 620 and 625, and from the first and the second electron-emitting members 640 and 643. Table 4 shows properties of the cold cathode type compact fluorescent lamp 600 including the ballast 670 therein tested by Korea Electric Testing Institute (KETI).

TABLE 4

| Property | sample 1 | sample 2 | sample 3 | sample 4 | sample 5 | sample 6 |
|---|---|---|---|---|---|---|
| input current (A) | 0.1391 | 0.1327 | 0.1180 | 0.1673 | 0.1765 | 0.1756 |
| input power (W) | 19.52 | 18.65 | 19.62 | 30.83 | 31.98 | 32.17 |
| luminous flux per | 1,334 | 1,292 | 1,346 | 2,400 | 2,440 | 2,450 |
| second (lm/s) | | | | | | |
| efficiency (lm/W) | 68.3 | 69.3 | 68.6 | 77.8 | 76.3 | 76.2 |

In Table 4, samples 1 to 3 are the cold cathode type compact fluorescent lamps 600 having luminous intensities of approximately 20W, and samples 4 to 6 are the cold cathode type compact fluorescent lamps 600 having luminous intensities of approximately 30W. As shown in Table 4, the cold cathode type compact fluorescent lamps 600 have good properties such as luminous flux per second, and efficiency.

Embodiment 7

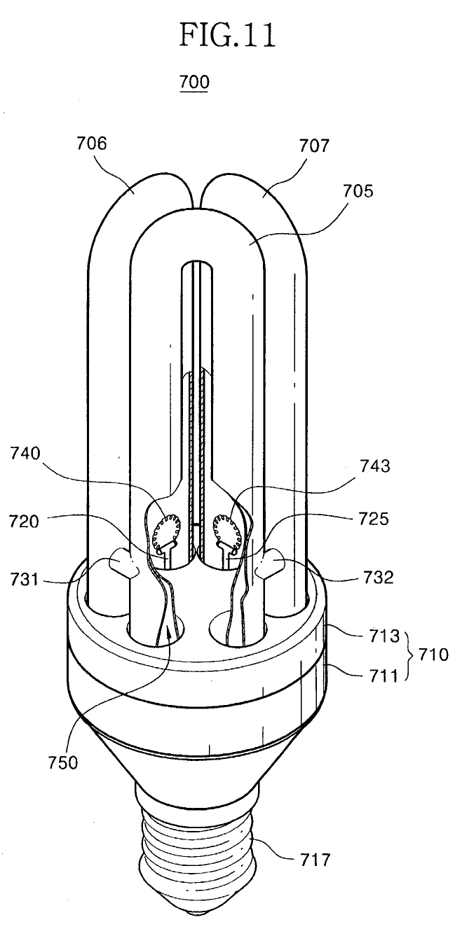

FIG. 11 is a partially projected perspective view illustrating a cold cathode type compact fluorescent lamp according to a seventh embodiment of the present invention.

Referring to FIG. 11, a cold cathode type compact fluorescent lamp 700 of the present embodiment includes a first fluorescent tube 705, a second fluorescent tube 706, a third fluorescent tube 707, a base 710, a socket 717, a first electrode 720, a second electrode 725, a first electron-emitting member 740, a second electron-emitting member 743, and a discharge gas 750.

According to the present embodiment, the cold cathode type compact fluorescent lamp 700 includes three fluorescent tubes 705, 706 and 707 substantially having “U” shapes. A first connecting member 731 connects the first fluorescent tube 705 to the second fluorescent tube 706, and a second connecting member 732 connects the first fluorescent tube 705 to the third fluorescent tube 707. Fluorescent materials are uniformly coated on inner walls of the first to the third fluorescent tubes 705, 706 and 707. The discharge gas 750 is also filled in the first to the third fluorescent tubes 705, 706 and 707.

The first electrode 720 is disposed in one end portion of the second fluorescent tube 706, and the second electrode 725 is positioned in one end portion of the third fluorescent tube 707. The first and the second electron-emitting members 740 and 743 are fixed on the first and the second electrodes 720 and 725, respectively. The first and the second electron-emitting members 740 and 743 include electron powders coated thereon, respectively. In this case, fixing members can be provided between the electron-emitting members 740 and 743 and the electrodes 720 and 725. In addition, discharge-improving members can be installed behind the first and the second electrodes 720 and 725, respectively.

The base 710 includes a plate 713 and a housing 711. Six holes are provided in the plate 713 for receiving the first to the third fluorescent tubes 705, 706 and 707. The socket 717 is coupled to the housing 711 by a screw or an adhesive.

In the present embodiment, a ballast installed in the housing 711 is identical to those of the sixth embodiment. Also, a first lead and a second lead are the same as those of the sixth embodiment as shown in FIG. 9.

Embodiment 8

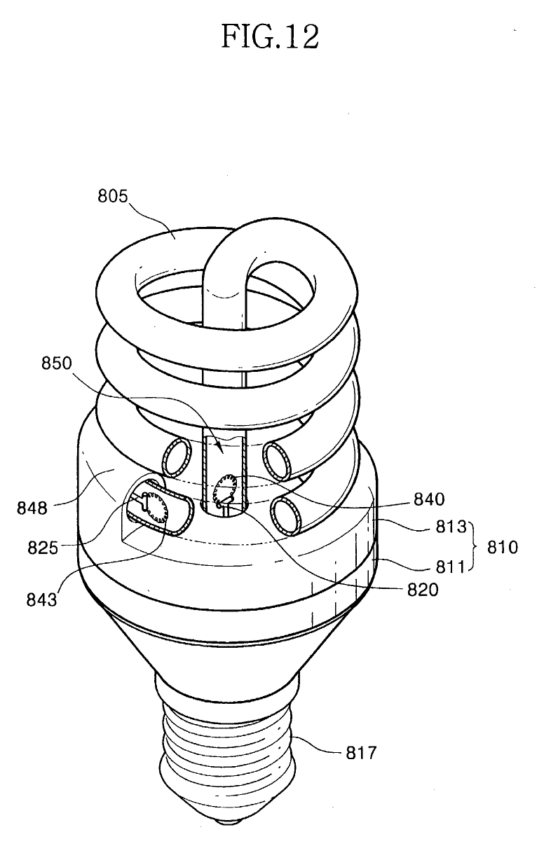

FIG. 12 is a partially cut perspective view illustrating a cold cathode type compact fluorescent lamp according to an eight embodiment of the present invention.

Referring to FIG. 12, a cold cathode type compact fluorescent lamp 800 of the present embodiment has a fluorescent tube 805, a base 810, a socket 817, a first electrode 820, a second electrode 825, a first electron-emitting member 840, a second electron-emitting member 843, and a discharge gas 850.

The base 810 includes a housing 811 to which the socket 817 is coupled, and a plate 813 having a hole and a fluorescent tube-receiving portion 848. One end portion of the fluorescent tube 805 is inserted in the hole, and the other end portion of the fluorescent tube 805 is received in the fluorescent tube-receiving portion 848.

The fluorescent tube 805 of the present embodiment includes a linear portion and a coil portion integrally formed with the linear portion. The linear portion of the fluorescent tube 805 is upwardly prolonged from the hole of the base 810, and then the coil portion 848 of the fluorescent tube 805 is spirally and downwardly prolonged to the fluorescent tube-receiving portion of the base 810. At that time, a diameter of the coil portion is constantly maintained. The discharge gas 850 including vapors of mercury and an inert gas is uniformly filled in the fluorescent tube 805. Also, a fluorescent material is uniformly coated on an entire inner wall of the fluorescent tube 805.

The first electrode 820 is disposed in the linear portion of the fluorescent tube 805, and the second electrode 825 is positioned in the coil portion of the fluorescent tube 805. The second electrode 825 is adjacent to the fluorescent tube-receiving portion 848 of the base 810. The first and the second electron-emitting members 840 and 843 are fixed on the first and the second electrodes 820 and 825, respectively.

As it is described above, fixing members can be formed for increasing stabilities of the first and the second electron-emitting members 840 and 843, and also at least one discharge-improving member can be installed behind at least one of the first and the second electrodes 820 and 825 in order to enhance a discharge efficiency of the cold cathode type compact fluorescent lamp 800.

Embodiment 9

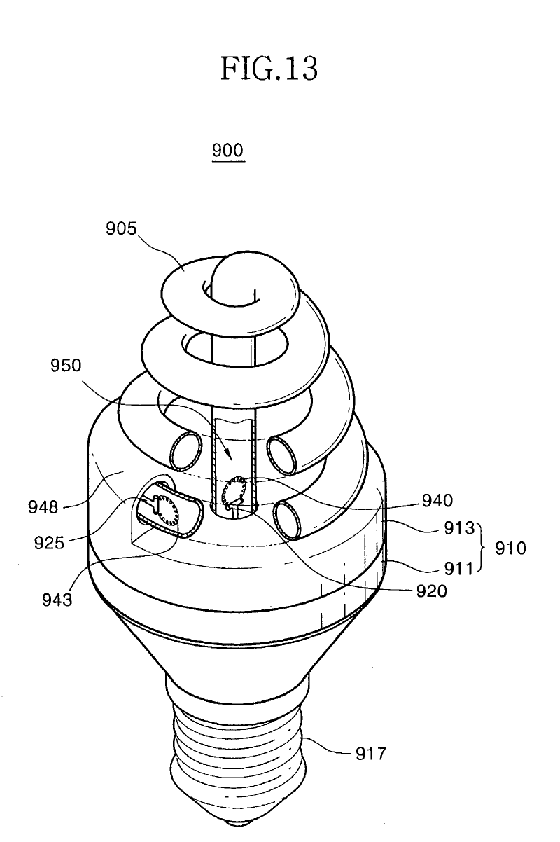

FIG. 13 is a partially cut perspective view illustrating a cold cathode type compact fluorescent lamp according to a ninth embodiment of the present invention.

Referring to FIG. 13, a cold cathode type compact fluorescent lamp 900 of the present embodiment has a fluorescent tube 905, a base 910, a socket 917, a first electrode 920, a second electrode 925, a first electron-emitting member 940, a second electron-emitting member 943, and a discharge gas 950.

The base 910 includes a housing 911 where the socket 917 is coupled, and a plate 913 having a hole and a fluorescent tube-receiving portion 948. One end portion of the fluorescent tube 905 is inserted in the hole, and the other end portion of the fluorescent tube 905 is received in the fluorescent tube-receiving portion 948.

The fluorescent tube 905 includes a linear portion and an enlarged coil portion integrally formed with the linear portion. The linear portion of the fluorescent tube 905 is upwardly prolonged from the hole of the base 810, and then the enlarged coil portion of the fluorescent tube 905 is spirally prolonged to the fluorescent tube-receiving portion 948 of the base 910 in a downward direction. At that time, a diameter of the enlarged coil portion is gradually augmented toward the fluorescent tube-receiving portion 948 of the base 910. When the fluorescent tube 905 has the enlarged coil portion, the cold cathode type compact fluorescent lamp 900 can have a greatly increased luminous efficiency per a unit area thereof.

The discharge gas 950 including vapors of mercury and an inert gas is uniformly filled in the fluorescent tube 905, and a fluorescent material is uniformly coated on an entire inner wall of the fluorescent tube 905.

The first electrode 920 is disposed in the linear portion of the fluorescent tube 905, and the second electrode 925 is positioned in the enlarged coil portion of the fluorescent tube 905. The second electrode 925 is adjacent to the fluorescent tube-receiving portion 948 of the base 810. The first and the second electron-emitting members 940 and 943 are fixed on the first and the second electrodes 920 and 925, respectively. In this case, fixing members can be interposed between the electron-emitting members 940 and 943 and the electrodes 920 and 925. Also, at least one discharge-improving member can be installed behind at least one of the first and the second electrodes 920 and 925.

In the present embodiment, first and second leads, and a ballast are identical to those of the sixth embodiment.

Embodiment 10

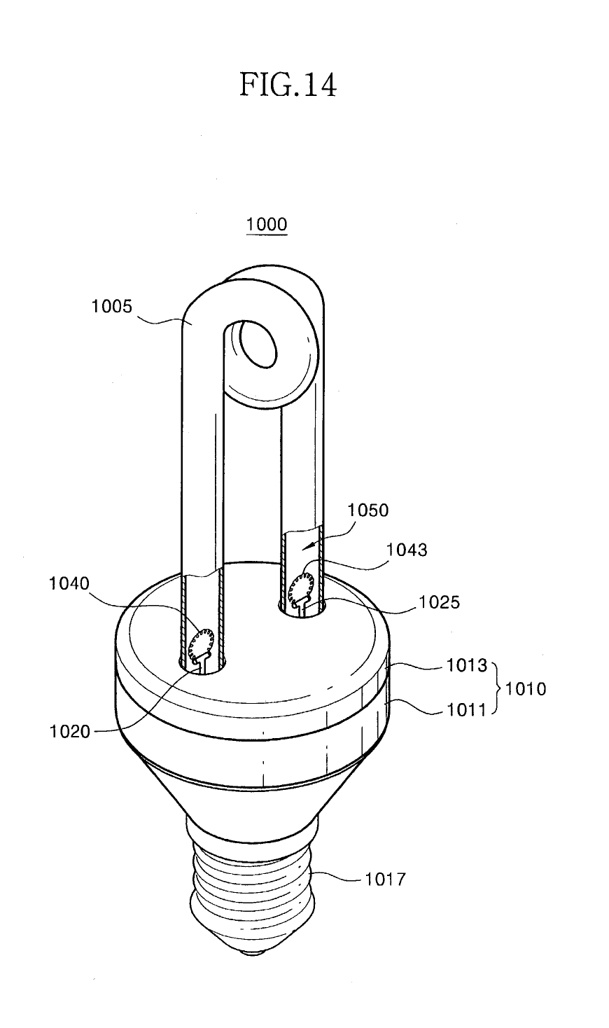

FIG. 14 is a partially projected perspective view illustrating a cold cathode type compact fluorescent lamp according to a tenth embodiment of the present invention.

Referring to FIG. 14, a cold cathode type compact fluorescent lamp 1000 of the present embodiment includes a fluorescent tube 1005, a base 1010, a socket 1017, a first electrode 1020, a second electrode 1025, a first electron-emitting member 1040, a second electron-emitting member 1043, and a discharge gas 1050.

The fluorescent tube 1005 of the present embodiment includes lateral linear portions, and a central coil portion. A plate 1013 of the base 1010 has two holes for receiving the linear portions of the fluorescent tube 1005. The base 1010 has a housing 1011 in which a ballast installed. The socket 1017 is coupled to the housing 1011.

The first electrode 1020 is disposed in one linear portion of the fluorescent tube 1005, and the second electrode 1025 is positioned in the other linear portion of the fluorescent tube 1005. The first and the second electron-emitting members 1040 and 1043 are fixed on the first and the second electrodes 1020 and 1025, respectively. At that time, fixing members can be interposed between the electron-emitting members 1040 and 1043 and the electrodes 1020 and 1025. Additionally, at least one discharge-improving member can be installed behind at least one of the first and the second electrodes 1020 and 1025.

The discharge gas 1050 including vapors of mercury and an inert gas is uniformly filled in the fluorescent tube 1005, and a fluorescent material is also uniformly coated on an entire inner wall of the fluorescent tube 1005.

As it is described above, the cold cathode type fluorescent lamp of the present invention is quite different from the conventional fluorescent lamp. The cold cathode type fluorescent lamp can instantaneously operate without pre-heating the electrodes, and cold cathode type fluorescent lamp can have greatly increased life in comparison with the conventional fluorescent lamp because the cold cathode type fluorescent lamp can continuously operate when the electron-emitting members are broken.

Also, the cold cathode type fluorescent lamp of the present invention can be employed for various purposes like a traffic lamp or a street lamp because the cold cathode type fluorescent lamp of the present invention has the sufficient luminous intensity while the conventional cold cathode fluorescent lamp has the limited luminous intensity for a small lighting.

In addition, the cold cathode type fluorescent lamp of the present invention can have more enhanced discharge efficiency due to the discharge-improving member so that the cold cathode type fluorescent lamp of the present invention can be advantageously applied to a place where a large lighting is demanded.

Furthermore, because the cold cathode type fluorescent lamp of the present invention can stably operate under a severe circumstance like a very cold or dry region, the cold cathode type fluorescent lamp of the present invention can have various applications.

Having described the preferred embodiments for the cold cathode type fluorescent lamps, it is noted that modifications and variations can be made by persons skilled in the art in light of the above teachings. It is therefore to be understood that changes may be made in the particular embodiment of the present invention disclosed which is within the scope and the spirit of the invention outlined by the appended claims.

What is claimed is:

1. A cold cathode type fluorescent lamp comprising:
a fluorescent tube wherein a fluorescent material is formed on an inside of the fluorescent tube;
a discharge gas filled in the fluorescent tube;
a first and a second bases installed at both end portions of the fluorescent tube, respectively;
a first electrode disposed in the fluorescent tube wherein the first electrode is adjacent to the first base;
a second electrode disposed in the fluorescent tube wherein the second electrode is adjacent to the second base;
a first electron-emitting means fixed on the first electrode; and
a second electron-emitting means fixed on the second electrode.

2. The cold cathode type fluorescent lamp of claim 1, wherein the discharge gas includes a vapor of mercury and a vapor of an inert gas.

3. The cold cathode type fluorescent lamp of claim 2, wherein the vapor of the inert gas includes a vapor of an argon gas.

4. The cold cathode type fluorescent lamp of claim 3, wherein a weight ratio between the vapor of mercury and the vapor of argon is between approximately 1:0.6 and 1:2.0.

5. The cold cathode type fluorescent lamp of claim 1, wherein the first electron-emitting means includes tungsten, nickel or titanium carbide, and the second electron-emitting means includes tungsten, nickel or titanium carbide.

6. The cold cathode type fluorescent lamp of claim 5, wherein the first and the second electron-emitting means have coil shapes or spring shapes formed by twisting about three to five strings, and electron powders are formed on surfaces of the first and the second electron-emitting means, respectively.

7. The cold cathode type fluorescent lamp of claim 1, further comprising a first and a second fixing means for fixing the first and the second electron-emitting means on the first and the second electrodes, respectively.

8. The cold cathode type fluorescent lamp of claim 7, wherein the first and the second fixing means include solderings, rivets, or holes formed through the first and the second electrodes, respectively.

9. The cold cathode type fluorescent lamp of claim 1, further comprising at least one discharge-improving means disposed behind at least one of the first and the second electrodes.

10. The cold cathode type fluorescent lamp of claim 9, wherein the discharge-improving means further comprises:
a reflection member for reflecting electrons emitted from at least one of the first and the second electron-emitting means; and
a supporting member for supporting the reflection member.

11. The cold cathode type fluorescent lamp of claim 10, wherein the reflection member includes a material having a thermal expansion coefficient identical to at least one of the first and the second electrodes.

12. The cold cathode type fluorescent lamp of claim 11, wherein the reflection member includes glass or quartz.

13. The cold cathode type fluorescent lamp of claim 1, wherein at least one of the first and the second electrodes extends toward a peripheral portion of the fluorescent tube for reflecting electrons emitted at least one of the first and the second electron-emitting means toward the discharge gas.

14. A cold cathode type fluorescent lamp comprising:
at least one fluorescent tube wherein a fluorescent material is formed on an inside of the fluorescent tube;
a discharge gas filled in the fluorescent tube;
a base for receiving both end portions of the fluorescent tube;
a first electrode disposed in a first portion of the fluorescent tube wherein the first electrode is adjacent to a first portion of the base;
a second electrode disposed in a second portion of the fluorescent tube wherein the second electrode is adjacent to a second portion of the base;
a first electron-emitting means fixed on the first electrode; and
a second electron-emitting means fixed on the second electrode.

15. The cold cathode type fluorescent lamp of claim 14, wherein the fluorescent tube includes a first and a second fluorescent tubes disposed parallel to each other, and a connecting member is formed between the first and the second fluorescent tubes in order to connect the first fluorescent to the second fluorescent tube.

16. The cold cathode type fluorescent lamp of claim 15, wherein the first and the second electrodes are positioned in the first and the second fluorescent tubes, respectively, and at least one discharge-improving means is installed behind at least one of the first and the second electrodes, wherein the discharge-improving means includes a reflection member for reflecting electrons emitted from at least one of the electron-emitting means toward the discharge gas, and a supporting member for supporting the reflection member.

17. A cold cathode type compact fluorescent lamp comprising:
a base including a housing having a first portion to which a socket is coupled, and a plate connected to a second portion of the housing;
a ballast installed in the housing;
at least one fluorescent tube installed on the plate wherein a fluorescent material is formed on an inside of the fluorescent tube;
a discharge gas filled in the fluorescent tube;
a first electrode disposed in a first portion of the fluorescent tube wherein the first electrode is adjacent to a first portion of the base;
a second electrode disposed in a second portion of the fluorescent tube wherein the second electrode is adjacent to a second portion of the base;
a first electron-emitting means fixed on the first electrode; and
a second electron-emitting means fixed on the second electrode.

18. The cold cathode type compact fluorescent lamp of claim 17, wherein the fluorescent tube includes a first, a second, a third fluorescent tubes disposed parallel to one after another, wherein a first connecting member is disposed between the first and the second fluorescent tubes in order to connect the first fluorescent to the second fluorescent tube, and a second connecting member is disposed between the first and the third fluorescent tubes in order to connect the first fluorescent to the third fluorescent tube.

19. The cold cathode type compact fluorescent lamp of claim 18, wherein the first and the second electrodes are positioned in the second and the third fluorescent tubes, respectively, and at least one discharge-improving means is installed behind at least one of the first and the second electrodes, wherein the discharge-improving means includes a reflection member for reflecting electrons emitted from at least one of the electron-emitting means toward the discharge gas, and a supporting member for supporting the reflection member.

20. The cold cathode type compact fluorescent lamp of claim 17, wherein the fluorescent tube includes a linear portion prolonged from the plate in an upward direction, and a coil portion spirally prolonged toward the plate in a downward direction.

21. The cold cathode type compact fluorescent lamp of claim 20, wherein the coil portion of the fluorescent tube gradually extends toward the plate.
